(19) United States
(12) Patent Application Publication
(10) Pub. No.: US 2016/0110222 A1
(43) Pub. Date: Apr. 21, 2016

(54) APPARATUS AND METHOD OF EXECUTING APPLICATION

(71) Applicant: SAMSUNG ELECTRONICS CO., LTD., Suwon-si (KR)

(72) Inventor: Hyo-won KIM, Incheon (KR)

(21) Appl. No.: 14/868,617

(22) Filed: Sep. 29, 2015

(30) Foreign Application Priority Data
Oct. 15, 2014 (KR) 10-2014- 0139073

(51) Int. Cl. G06F 9/50; G06F 11/30; G06F 3/0482; G06F 11/34

(52) U.S. Cl. CPC G06F 9/5011; G06F 11/3409; G06F 11/3024; G06F 3/0482

(57) ABSTRACT

A method and apparatus for executing an application which provides a graphical user interface (GUI) is provided, the method including, determining a score based on resource usage of a UI element provided by the GUI for user interaction, and allocating resources to the UI element based on the determined score.

### CROSS-REFERENCE TO RELATED APPLICATION

This application is based on and claims priority under 35 U.S.C. §119 to Korean Patent Application No. 10-2014-0139073, filed on Oct. 15, 2014, in the Korean Intellectual Property Office, the disclosure of which is incorporated herein in its entirety by reference.

### BACKGROUND

1. Field

The disclosure relates to methods and apparatuses for executing an application.

2. Description of Related Art

In executing applications which provide graphical user interfaces (GUIs), UI elements including animation effects are becoming more and more varied. As graphic effects of UI elements become spectacular, the amount of resources required to execute the UI elements also increases.

However, according to the related art, restricted resources are distributed en bloc to each UI execution process regardless of the kind of UI. Accordingly, when various UI execution processes are performed simultaneously, resources are insufficient, and thus, unnatural effects, such as lagging of animation, may be caused.

Therefore, research on methods of allocating resources efficiently in devices having restricted resources to prevent shortage of resources is needed.

### SUMMARY

Provided are methods and apparatuses for executing an application.

Additional aspects will be set forth in the description which follows and, will be apparent from the description.

According to an aspect of an example embodiment, a method of executing an application which provides a graphical user interface (GUI) includes: determining a score for the UI element based on resource usage of a UI element provided by the GUI for user interaction; and allocating resources to the UI element based on the determined score.

Determining a score may be based on a basic score determined based on at least one of a central processing unit (CPU) usage rate, a memory usage rate, CPU usage duration, and memory usage duration of the UI element.

The method may further include increasing the basic score when at least one of the CPU usage rate and the memory usage rate needed to execute the UI element increase or when the CPU usage duration and the memory usage duration needed to execute the UI element increase.

Determining may include adding a weight to the basic score, wherein the weight may be manually set by a user input or automatically determined based on a predetermined criterion.

Allocating of the resources may include allocating the UI element to one of the processors, among the priorities of which are set as high, middle, and low, based on the score.

The UI element may include at least one of a button, a list, a drop down list, a context menu, and a sliding animation.

Determining of the score for the UI element may differ based on a type of the application.

The determined score of the UI element may be stored in a storage apparatus and reused.

The score for the UI element may be determined when the application is executed or an apparatus for executing an application is executing.

According to an aspect of an example embodiment, a device for executing an application which provides a GUI includes a processor configured to determine, based on resource usage of a UI element provided by the GUI for user interaction, a score for the UI element, and to allocate resources to the UI element based on the determined score, and a display configured to display the UI element.

The processor may be configured to determine the score based on a basic score determined based on at least one of a central processing unit (CPU) usage rate, a memory usage rate, CPU usage duration, and memory usage duration of the UI element.

The processor may be configured to increase the basic score when at least one of the CPU usage rate and the memory usage rate needed to execute the UI element increase or when the CPU usage duration and the memory usage duration needed to execute the UI element increase.

The processor may be configured to determine the score by adding a weight to the basic score, wherein the weight may be manually set by a user input or automatically determined based on a predetermined criterion.

The processor may be configured to allocate the UI element to one of the processor among the priorities of which are set as high, middle, and low, based on the score.

The UI element may include at least one of a button, a list, a drop down list, a context menu, and a sliding animation.

The processor may be configured to determine the score for the UI element differently based on a type of the application.

The device may further include a storage unit configured to store the determined score of the UI element.

The processor may be configured to determine the score for the UI element when the application is executed or an apparatus for executing an application is executing.

According to an aspect of an example embodiment, a non-transitory computer-readable recording medium having recorded thereon a program for, when executed by a computer, performing the method.

### BRIEF DESCRIPTION OF THE DRAWINGS

These and/or other aspects will become apparent and more readily appreciated from the following detailed description taken in conjunction with the accompanying drawings in which like reference numerals refer to like elements, and wherein:

FIG. 1 is a diagram illustrating an example of a user interface (UI) element to describe a concept of the UI element;

FIG. 2 is a block diagram illustrating a device for executing an application;

FIG. 3 is a flowchart illustrating a method of executing an application;

FIG. 4 is a detailed flowchart illustrating a method of executing an application;

FIG. 5 is a diagram illustrating an example of scores for UI elements;

FIG. 6 is a flowchart illustrating a method of executing an application;

FIG. 7 is a diagram illustrating an example of classifying UI elements into three steps based on scores for the UI elements;

FIG. 8 is a diagram illustrating a logical hierarchy structure of a device for executing an application;

FIG. 9 is a diagram illustrating a method of allocating UI elements to a processor set as three steps;

FIG. 10 is another block diagram illustrating a device for executing an application;

FIG. 11A is a diagram illustrating displaying, by a device for executing an application, a game application;

FIG. 11B is a diagram illustrating scores determined for UI elements of the game application;

FIG. 12A is a diagram illustrating displaying, by a device for executing an application, a web browser application; and

FIG. 12B is a diagram illustrating scores determined for UI elements of the web browser application.

### DETAILED DESCRIPTION

The features of the disclosure and example methods of accomplishing the same will become apparent from the following description, taken in conjunction with the accompanying drawings. The disclosure may, however, be embodied in many different forms and should not be construed as limited to the example embodiments set forth herein. Rather, these example embodiments are provided to convey the scope of the disclosure to one of ordinary skill in the art, and the disclosure is defined by the scope of claims.

Terms used herein will be briefly explained, and then, example embodiments will be described in detail.

The terms used herein are selected from among common terms that are currently widely used in consideration of their functions in the disclosure. However, the terms may be different according to the intention of one of ordinary skill in the art, precedent, or the advent of new technology. Also, in particular cases, the terms are discretionally selected by the present applicant, and the meaning of those terms may be described in detail in the corresponding part of the detailed description. Therefore, the terms used in the example embodiments are not merely designations of the terms, but the terms are defined based on the meaning of the terms and content throughout the specification.

Throughout the disclosure, when a part “includes” an element, it is to be understood that the part may additionally include other elements rather than excluding other elements as long as there is no particular opposing recitation. Also, the term “unit” used herein refers to a software component or a hardware component such as, electronic circuitry, a field-programmable gate array (FPGA) or an application-specific integrated circuit (ASIC), and performs a certain function. However, the term “unit” is not limited to software or hardware. The “unit” may be configured so as to be in an addressable storage medium, or may be configured so as to operate one or more processors. Thus, for example, the term “unit” may refer to components such as software components, object-oriented software components, class components, and task components, and may include processes, functions, attributes, procedures, subroutines, segments of a program code, drivers, firmware, a microcode, a circuit, data, a database, data structures, tables, arrays, or variables. A function provided by the components and “units” may be associated with the smaller number of components and “units”, or may be divided into additional components and “units”.

Reference will now be made in detail to example embodiments, examples of which are illustrated in the accompanying drawings, wherein like reference numerals refer to like elements throughout, so that the example embodiments may be apparent to one of ordinary skill in the art. Also, parts in the drawings unrelated to the detailed description are omitted to ensure clarity of the present disclosure. Expressions such as “at least one of,” when preceding a list of elements, modify the entire list of elements and do not modify the individual elements of the list.

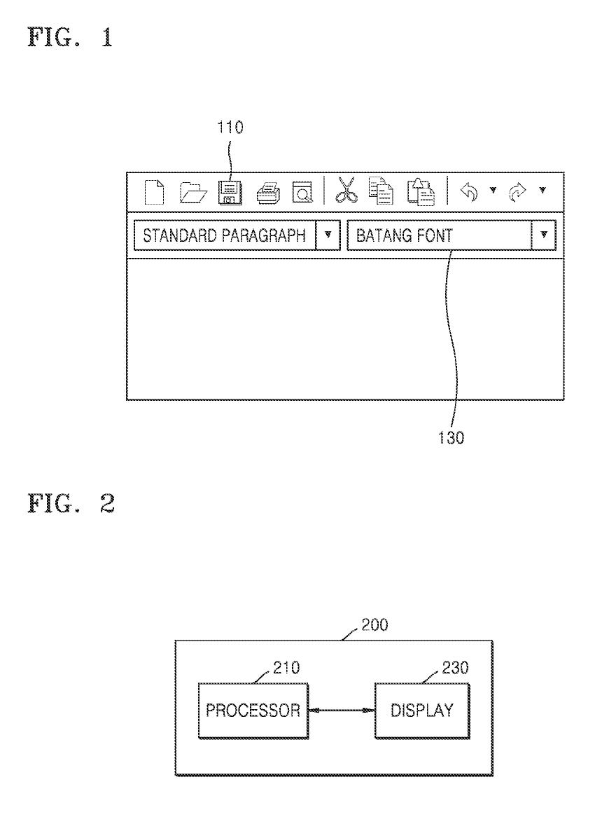

FIG. 1 is a diagram illustrating an example of a user interface (UI) element to describe a concept of the UI element.

The term “UI element” used herein refers, for example, to an item provided by a graphical user interface (GUI) for user interaction. For example, a menu that is a part of the GUI or an effect obtained by executing the menu may be commonly called a UI element.

Examples of the UI element may, for example, include a button, a list, a drop down list, a context menu, a sliding animation, a Fovea animation, or the like.

A GUI of FIG. 1 includes two UI elements, a button 110 and a drop down list 130.

In FIG. 1, each icon has been represented using the button 110, and a standard paragraph and a batang font have each been represented using the drop down list 130.

The drop down list 130 is a list on which, for example, when a downward arrow is selected, a menu may display additional information as the menu extends downward in a sliding manner, and a UI element that represents the menu extending downward in a sliding manner is a sliding animation.

When various kinds of UI elements (menus) configuring the GUI are selected as such, selected contents may be represented by using various animation effects, and the animation effects used to represent the selected contents may be UI elements.

FIG. 2 is a block diagram illustrating a device 200 for executing an application.

The device 200 may, for example, be one of a cell phone, a personal digital assistant (PDA), a notebook computer, a smart television (TV), another multi-functional display apparatus, a display apparatus such as an entertainment apparatus, or the like.

The device 200 may include a processor 210 and a display 230.

In executing an application which provides a GUI, the processor 210 may be configured to determine a score indicating resource usage of each UI element, and may allocate resources to the UI element based on the determined score.

In some example embodiments, the processor 210 may include a score determining unit for determining a score indicating resource usage of a UI element, and a load balancer for allocating resources to the UI element according to the determined score.

The output device 230 may display UI elements performed using resources allocated by the processor 210. The output device 230 may communicate with an external apparatus in various ways.

In the example embodiment, the processor 210 and the output device 230 are represented as separate units. However, in some example embodiments, the processor 210 and the output device 230 may be integrated to be a single unit.

Also, in the example embodiment, the processor 210 and the output device 230 are units positioned in the device 200 to be adjacent to each other. However, apparatuses respectively performing functions of the processor 210 and the output device 230 do not necessarily need to be physically adjacent to each other. Accordingly, in some example embodiments, the processor 210 and the output device 230 may be separate from one another.

Also, since the device 200 is not limited to a physical apparatus, some functions of the device 200 may be implemented not by hardware but by software.

In some example embodiments, the device 200 may further include an input unit for receiving a user input.

In some example embodiments, the device 200 may further include a storage unit for storing a score indicating each UI element.

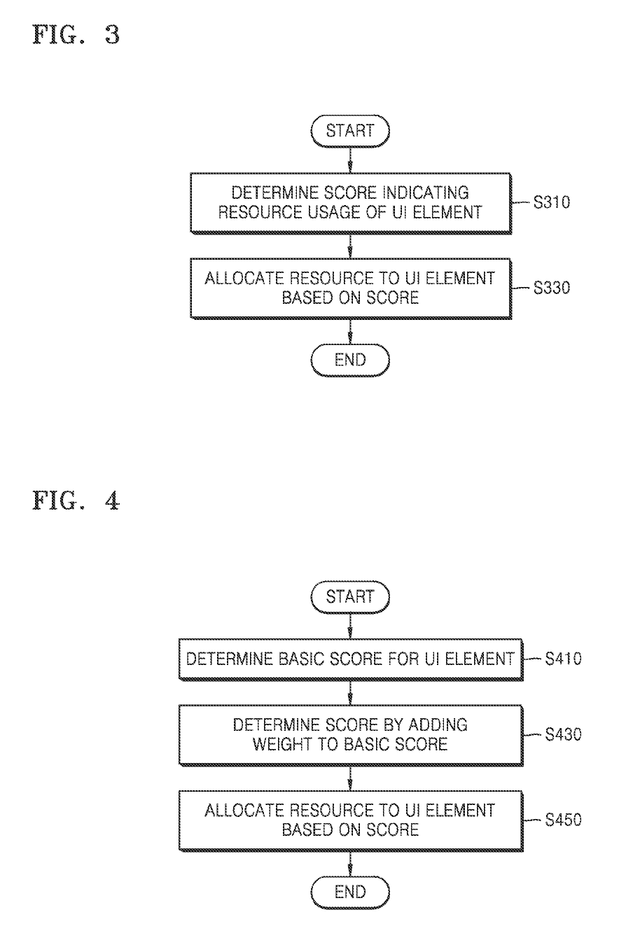

FIG. 3 is a flowchart illustrating a method of executing an application.

In operation S310, the device 200 for executing an application may determine a score indicating resource usage of each UI element.

The score indicating resource usage of each UI element may be obtained by converting a required amount of resources, which includes at least one of a central processing unit (CPU) usage rate, a memory usage rate, CPU usage duration, and memory usage duration needed to execute or display the UI element into a score.

The score indicating resource usage of a UI element may have a high value as a required amount of resources needed to execute or display the UI element increases. For example, among UI elements, a required amount of resources needed to display a button is less than a required amount of resources needed to display a sliding animation. Accordingly, a score indicating resource usage of the button may, for example, be less than a score indicating resource usage of the sliding animation.

In some example embodiments, the device 200 may manage the score indicating resource usage of a UI element of all applications executed by the device 200 together.

In some example embodiments, the device 200 may manage the score indicating resource usage of a UI element of each application executed by the device 200 respectively.

In operation S330, the device 200 may allocate resources to the UI element based on the determined score.

The device 200 may, for example, be equipped with an operating system (OS) such as Windows, Linux, iPhone OS (iOS) of Apple Inc., Google Android, or the like. Each OS may provide a system application programming interface (API) that may adjust priorities of generated processes. Through the system API, the device 200 may allocate each of the processes to the UI element based on a priority of the process.

For example, the device 200 may classify each of the processes into three steps, and may allocate one of the three steps of the process to the UI element based on the score indicating resource usage of the UI element.

Through the allocation operation, the device 200 may allocate increased resources to a UI element having a high score, that is, a large required amount of resources, and thus may allocate resources efficiently.

FIG. 4 is a flowchart illustrating a method of executing an application.

In operation S410, the device 200 for executing an application may determine a basic score for each UI element. The basic score may, for example, be determined based on a CPU usage rate, a memory usage rate, CPU usage duration, and memory usage duration of the UI element. For example, as the CPU usage rate and the memory usage rate needed to execute the UI element increase, the device 200 may increase the basic score for the UI element. Also, as the CPU usage duration and the memory usage duration needed to execute the UI element increase, the device 200 may increase the basic score for the UI element.

In some example embodiments, when the device 200 is booted, the device 200 may determine a basic score for each UI element.

In some example embodiments, when a certain application is executed, the device 200 may determine basic scores for UI elements of the certain application.

In operation S430, the device 200 may determine a final score by, for example, adding a weight to the determined basic score.

The weight may be manually determined by a user input or automatically determined based on a predetermined criterion.

In some example embodiments, a developer of the application may predetermine the weight.

The weight may be assigned to UI elements that may, for example, be statistically displayed first on a screen of the device 200 based on an analysis of the execution history of the UI elements.

In some example embodiments, only whether the weight is to be assigned or not may be determined.

In some example embodiments, a size or degree of the weight may be determined.

In operation S450, the device 200 may allocate resources to the UI element based on a score for the UI element.

In this regard, the score may, for example, refer to a final score obtained by adding a weight to a basic score indicating resource usage of the UI element.

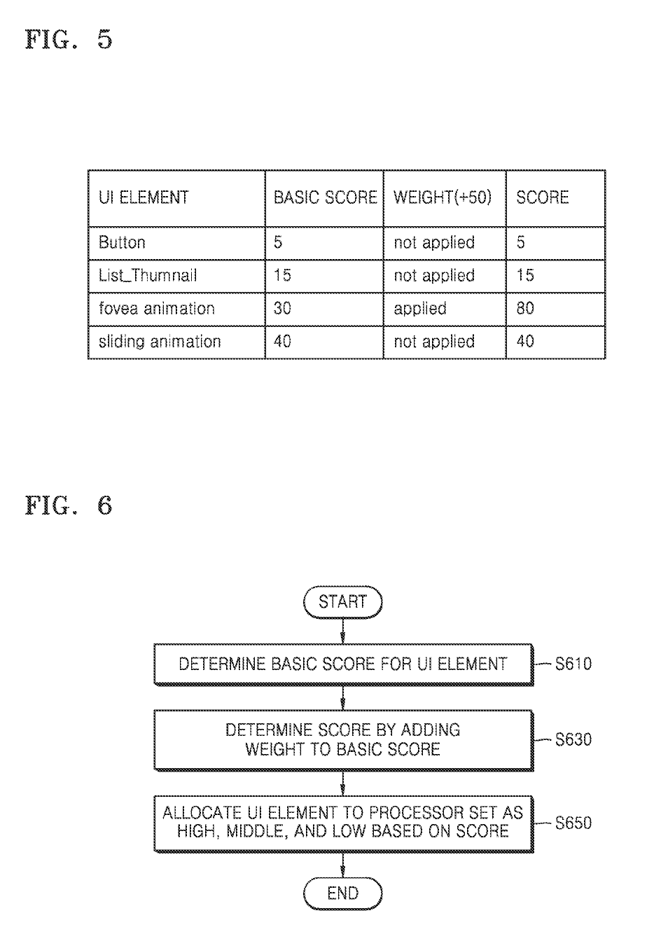

FIG. 5 is a diagram illustrating an example of scores for UI elements.

According to an example embodiment, a basic score, a weight, and a score, which is obtained by adding the weight to the basic score, are provided for resource usage of a button, a list thumbnail, a Fovea animation, and a sliding animation from among the UI elements.

In the example embodiment, the weight is uniformly set as 50. However, in some example embodiments, the weight may be applied differently to each of the UI elements.

Since a basic score indicating resource usage of the button is 5, and no weight has been applied thereto, a total score for the button may be determined as 5.

Since a basic score indicating resource usage of the list thumbnail is 15, and no weight has been applied thereto, a total score for the list thumbnail may be determined as 15.

Since a basic score indicating resource usage of the Fovea animation is 30, and the weight has been applied thereto, a total score for the Fovea animation may be determined as 80.

Since a basic score indicating resource usage of the sliding animation is 40, and no weight has been applied thereto, a total score for the sliding animation may be determined as 40.

In some example embodiments, the scores indicating resource usage of the UI elements may be flexibly changed.

The device 200 may, for example, store a determined basic score, weight, and score for each UI element in the storage unit so that the determined basic score, weight, and score may be used in case of need.

FIG. 6 is a flowchart illustrating a method of executing an application.

In operation S610, the device 200 for executing an application may determine basic scores for UI elements.

In operation S630, the device 200 may determine final scores by adding a weight to the determined basic scores.

In operation S650, the device 200 may allocate the UI elements to processors, the priorities of which are set as three steps, that is, high, middle, and low, based on the scores for the UI elements.

A processor, the priority of which is set as high, may have more available resources than a processor, the priority of which is set as middle or low. For example, a priority of a processor may be determined based on an amount of available resources allocated to the processor.

Each of the processors may be assorted in terms of hardware or may be assorted only in terms of software.

The device 200 may classify an OS processor of the device 200 into three steps, that is, high, middle, and low, based on priorities. Thus, the device 200 may allocate a UI element having a relatively high score for resources to a processor having a high priority and may allocate another UI element having a relatively low score for resources to a processor having a low priority.

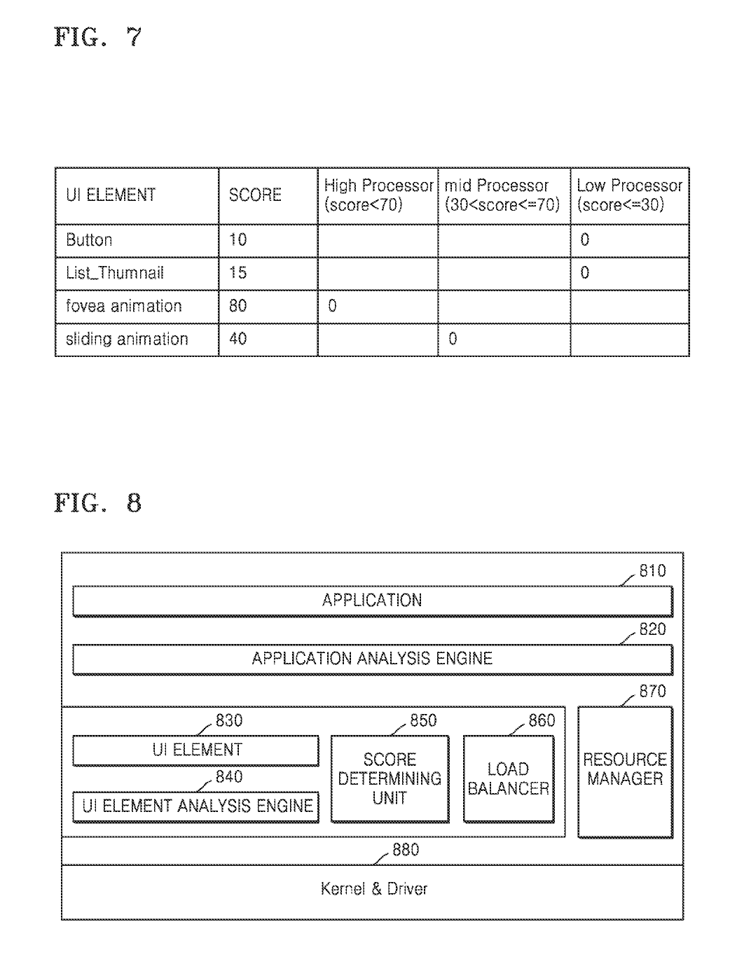

FIG. 7 is a diagram illustrating an example of classifying UI elements into three steps based on scores for the UI elements.

In the example embodiment, scores for a button, a list thumbnail, a Fovea animation, and a sliding animation have been respectively determined as 10, 15, 80, and 40. A process of determining the scores for those UI elements may be the same as described above with reference to FIG. 5.

If a score indicating resource usage of a UI element is greater than 70, the device 200 may allocate the UI element to the processor, the priority of which is set as high.

If the score indicating resource usage of a UI element is greater than 30 and less than or equal to 70, the device 200 may allocate the UI element to the processor, the priority of which is set as middle.

If the score indicating resource usage of a UI element is equal to or less than 30, the device 200 may allocate the UI element to the processor, the priority of which is set as low.

In the example embodiment, the button and the list thumbnail may be allocated to the processor, the priority of which is set as low, the sliding animation may be allocated to the processor, the priority of which is set as middle, and the Fovea animation may be allocated to the processor, the priority of which is set as high.

When the button is selected while the application displays the button and the list thumbnail as menus, the device 200, in the case of being programmed to execute the Fovea animation and the sliding animation, may measure scores indicating resource usage of each of the UI elements.

Also, the device 200 may allocate resources based on the scores indicating resource usage of each of the UI elements, as in the example embodiment.

When the application is executed, the device 200 may display the button and the list thumbnail using the processor, the priority of which is set as low. When an input of pressing the button is received, the device 200 may display the Fovea animation using the processor, the priority of which is set as high, and may display the sliding animation by using the processor, the priority of which is set as middle.

Through the above process, the device 200 may differentially allocate restricted resources based on a degree of need for resources and importance, and thus may efficiently use the restricted resources.

In some example embodiments, criteria for scores indicating resource usage of UI elements to be allocated to processors, the priorities of which are set as high, middle, and low, may be different from those in the present example embodiment.

FIG. 8 is a diagram illustrating a logical hierarchy structure of a device for executing an application.

An application 810 may be on the top level of the logical hierarchy structure, and an application analysis engine 820 for analyzing and executing the application 810 may come next.

A UI element 830, which is a part of a menu configuring a GUI of the application 810 and a method of displaying an execution result of the application 810, may be on a lower level of the application analysis engine 820, and a UI element analysis engine 840 for analyzing and displaying the UI element 830 may come next.

A score determining unit 850 for determining a score indicating resource usage of each UI element 830 and a load balancer 860 for allocating resources based on the determined score may assist operations of the UI element analysis engine 840.

A resource manager 870 may schedule available resources and may allocate resources among applications 810 to be executed.

A kernel and driver 880 may classify processors by determining priorities of the processors or may manage and control hardware.

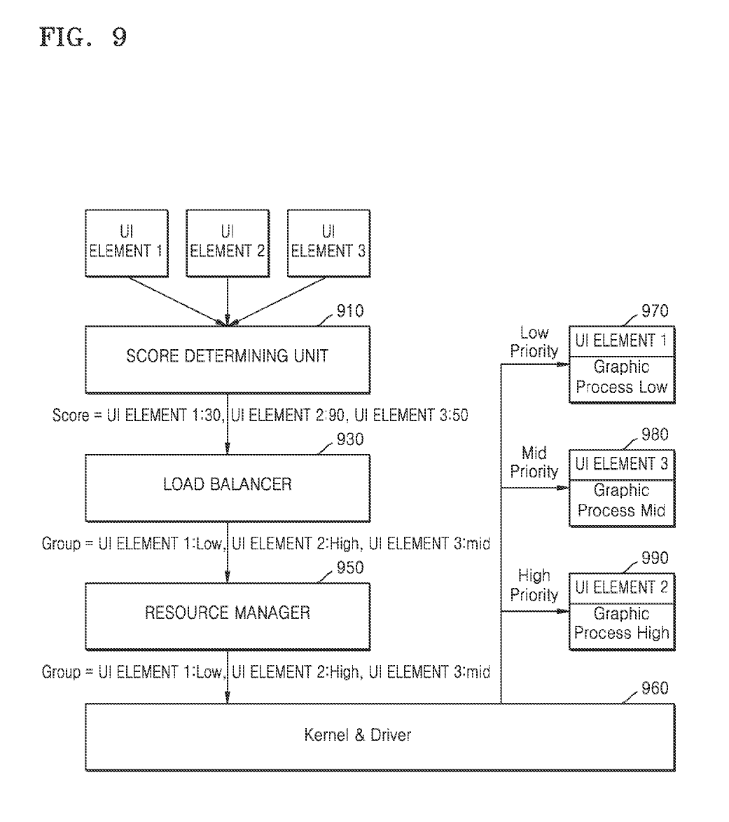

FIG. 9 is a diagram illustrating a method of allocating UI elements to a processor set as three steps.

A score determining unit 910 may determine scores of 30, 90, and 50 respectively for UI element 1, UI element 2, and UI element 3.

A load balancer 930 may assign the UI element 1 a low priority, the UI element 2 a high priority, and the UI element 3 a middle priority.

A resource manager 950 may schedule available resources and thus may allocate resources among the UI element 1, the UI element 2, and the UI element 3.

A kernel and driver 960 may classify processors as high, middle and low by determining priorities of the processors, and may control hardware accordingly.

As a result, the UI element 1 may be executed by a process having a low priority 970, the UI element 2 may be executed by a process having a middle priority 980, and the UI element 3 may be executed by a process having a high priority 990.

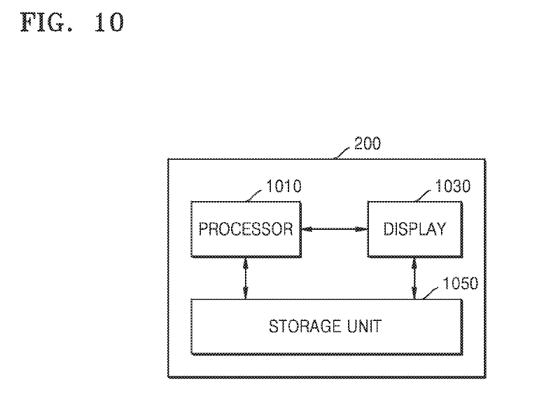

FIG. 10 is another block diagram illustrating the device 200 for executing an application.

The device 200 may include a processor 1010, a display 1030, and a storage unit 1050.

The device 200 may store a score indicating resource usage of a UI element, the score determined by the processor 1010, in the storage unit 1050.

Additionally, the score indicating resource usage of a UI element, the storage unit 1050 may separately store additional information such as a basic score indicating resource usage of the UI element, and a weight.

The storage unit 1050 may, for example, be volatile memory, non-volatile memory, internal memory, external memory, or a combination thereof. For example, the storage unit 1050 may be non-volatile memory such as non-volatile random access memory (NVRAM), flash memory, or a disk unit, or a volatile memory such as static random access memory (SRAM).

The storage unit 1050 may, for example, include a storage interface, which may be used for communication with another unit and an external device. The storage interface may receive information from the other device or an external transmitter and may also transmit information to the other device or an external destination.

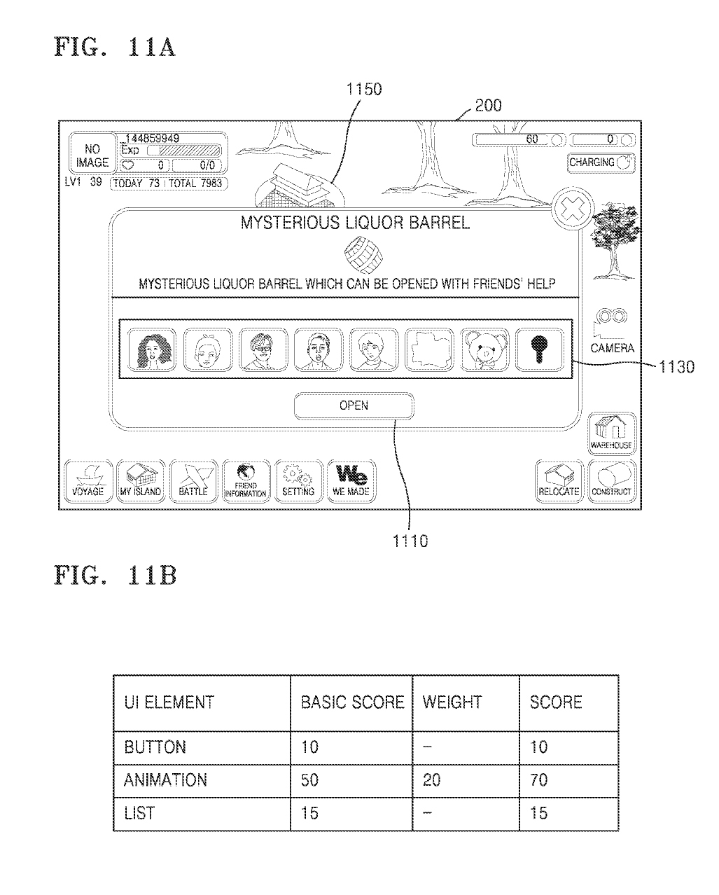

FIG. 11A is a diagram illustrating displaying, by the device 200 for executing an application, a game application.

The device 200 may execute various types of applications, and game types of applications may be one of the various kinds of applications.

As illustrated in an execution screen of FIG. 11A, the game application may include UI elements such as a button 1110, a list 1130, and an animation 1150.

FIG. 11B is a diagram illustrating scores determined for the UI elements of the game application.

The device 200 may determine a score indicating resource usage of each of the UI elements of the game application.

In the example embodiment, no weight has been applied to a basic score of 10 for a button, and accordingly, a score for the button has been finally determined as 10. A weight of 20 has been applied to a basic score of 50 for an animation, and accordingly, a final score for the animation is determined to be 70. Also, no weight has been applied to a basic score of 15 for a list, and accordingly, a score for the list has been finally determined as 15.

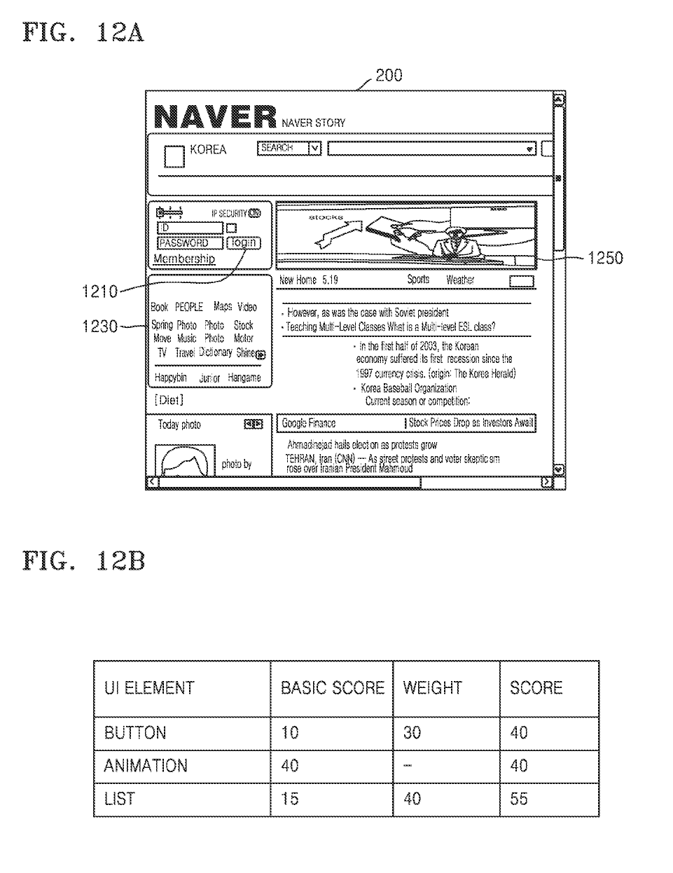

FIG. 12A is a diagram illustrating displaying, by the device 200 for executing an application, a web browser application.

The device 200 may also execute web browser types of applications.

Similarly to the game application of FIG. 11A, the web browser application may also include UI elements such as a button 1210, a list 1230, and an animation 1250.

FIG. 12B is a diagram illustrating scores determined for the UI elements of the web browser application.

The device 200 may determine a score indicating resource usage of each of the UI elements of the web browser application.

In the example embodiment, a weight of 30 has been applied to a basic score of 10 for a button, and accordingly, a final score for the button is determined to be 40. No weight has been applied to a basic score of 40 for an animation, and accordingly, a score for the animation has been finally determined as 40. Also, a weight of 40 has been applied to a basic score of 15 for a list, and accordingly, a final score for the list is determined to be 55.

As illustrated in FIG. 11B and FIG. 12B, scores indicating resource usage for identical UI elements may be determined differently based on the application and the application type, and UI elements allocated to a processor set as high, middle, and low may be different based on determined scores.

While one or more example embodiments have been described with reference to the figures, it will be understood by those of ordinary skill in the art that various changes in form and details may be made therein without departing from the spirit and scope as defined by the following claims. Hence, it should be understood that example embodiments described herein should be considered in a descriptive sense only and not for purposes of limitation. For example, each component described in a single type may be executed in a distributed manner, and components described as distributed may also be executed in an integrated form.

The scope of the disclosure is indicated by the following claims, and it should be understood that the claims and all modifications or modified forms drawn from the claims are encompassed in the scope.

What is claimed is:

1. A method of executing an application which provides a graphical user interface (GUI), comprising:
determining a score for the UI element based on resource usage of a UI element provided by the GUI for user interaction; and
allocating resources to the UI element based the determined score.

2. The method of claim 1, wherein determining is based on a basic score determined based on at least one of a central processing unit (CPU) usage rate, a memory usage rate, CPU usage duration, and memory usage duration of the UI element.

3. The method of claim 2, further comprising increasing the basic score when at least one of the CPU usage rate and the memory usage rate needed to execute the UI element increase or when the CPU usage duration and the memory usage duration needed to execute the UI element increase.

4. The method of claim 2, wherein determining comprises adding a weight to the basic score,
wherein the weight is manually set or automatically determined based on a predetermined criterion.

5. The method of claim 1, wherein allocating of the resources comprises allocating, based on the score, the UI element to one of the processors, in accordance with a priority of the processors, each of which is set as one of high, middle, and low.

6. The method of claim 1, wherein the UI element comprises at least one of a button, a list, a drop down list, a context menu, and a sliding animation.

7. The method of claim 1, wherein determining of the score for the UI element differs based on a type of the application.

8. The method of claim 1, wherein the determined score of the UI element is stored in a storage apparatus and reused.

9. The method of claim 1, wherein the score for the UI element is determined when the application is executed or an apparatus for executing an application is executing.

10. A device for executing an application which provides a graphical user interface (GUI), the device comprising:
a processor configured to determine, based on resource usage of a UI element provided by the GUI for user interaction, a score for the UI element, and to allocate resources to the UI element based on the determined score; and
a display configured to display the UI element.

11. The device of claim 10, wherein the processor is configured to determine the score based on a basic score determined based on at least one of a central processing unit (CPU) usage rate, a memory usage rate, CPU usage duration, and memory usage duration of the UI element.

12. The device of claim 11, wherein the processor is configured to increase the basic score when at least one of the CPU usage rate and the memory usage rate needed to execute the UI element increase or when the CPU usage duration and the memory usage duration needed to execute the UI element increase.

13. The device of claim 11, wherein the processor is configured to determine the score by adding a weight to the basic score,
wherein the weight is manually set or automatically determined based on a predetermined criterion.

14. The device of claim 11, wherein the processor is configured to allocate, based on the score, the UI element to one of the processors in accordance with a priority of the processors, each of which are set to one of high, middle, and low.

15. The device of claim 11, wherein the UI element comprises at least one of a button, a list, a drop down list, a context menu, and a sliding animation.

16. The device of claim 11, wherein the processor is configured to determine the score for the UI element differently based on a type of the application.

17. The device of claim 11, further comprising a memory configured to store the determined score of the UI element.

18. The device of claim 11, wherein the processor is configured to determine the score for the UI element when the application is executed or an apparatus for executing an application is executing.

19. A non-transitory computer-readable recording medium having recorded thereon a program, which, when executed by a computer, performs the method of claim 1.
